(19) United States
(12) Patent Application Publication
(10) Pub. No.: US 2026/0024837 A1
(43) Pub. Date: Jan. 22, 2026

(54) ELECTRICITY STORAGE APPARATUS

(71) Applicant: Toyota Jidosha Kabushiki Kaisha, Toyota-shi (JP)

(72) Inventor: Hiroshi OTAKE, Toyota-shi (JP)

(73) Assignee: Toyota Jidosha Kabushiki Kaisha, Toyota-shi (JP)

(21) Appl. No.: 19/201,098

(22) Filed: May 7, 2025

(30) Foreign Application Priority Data
Jul. 17, 2024 (JP) 2024-113977

(51) Int. Cl. H01M 10/6552; H01M 10/613; H01M 10/653; H01M 10/6557; H01M 50/204; H01M 50/249; H01M 50/262; H01M 50/289; H01M 50/507

(52) U.S. Cl. CPC H01M 10/6552; H01M 10/613; H01M 10/653; H01M 10/6557; H01M 50/249; H01M 50/262; H01M 50/289; H01M 50/507; H01M 50/204

(57) ABSTRACT

An electricity storage apparatus includes a plurality of electricity storage modules, a joining bracket configured to join adjacent electricity storage modules out of the electricity storage modules to each other, and a cooling pipe through which a refrigerant flows. The joining bracket and the cooling pipe are in thermal contact with each other.

### CROSS-REFERENCE TO RELATED APPLICATION

This application claims priority to Japanese Patent Application No. 2024-113977 filed on Jul. 17, 2024. The disclosure of the above-identified application, including the specification, drawings, and claims, is incorporated by reference herein in its entirety.

### BACKGROUND

### 1. Technical Field

The present disclosure relates to an electricity storage apparatus.

### 2. Description of Related Art

Japanese Unexamined Patent Application Publication No. 2016-219262 (JP 2016-219262 A) discloses a battery pack including a bracket that joins adjacent battery modules to each other.

### SUMMARY

In the battery pack of JP 2016-219262 A, the following occurs. When one battery module (electricity storage module) causes thermal runaway, there is a risk that the heat is conducted to another battery module via the bracket (joining member) and thermal runaway is caused in the other battery module.

The present disclosure has been made in order to solve the problem described above, and an object thereof is to provide an electricity storage apparatus capable of reducing heat conduction between adjacent electricity storage modules via a joining member.

An electricity storage apparatus according to one aspect of the present disclosure includes a plurality of electricity storage modules, a joining member configured to join adjacent electricity storage modules out of the electricity storage modules to each other, and a cooling pipe through which a refrigerant flows. The joining member and the cooling pipe are in thermal contact with each other.

In the electricity storage apparatus according to one aspect of the present disclosure, as described above, the joining member and the cooling pipe are in thermal contact with each other. As a result, even when thermal runaway is caused in one electricity storage module, for example, the joining member can be cooled by the refrigerant that flows through the cooling pipe. Therefore, it becomes possible to reduce the conduction of heat to the other electricity storage module. In other words, it becomes possible to reduce heat conduction between the adjacent electricity storage modules via the joining member. As a result, it becomes possible to reduce cases in which thermal runaway occurs in a chain-reaction manner in the electricity storage modules.

With the present disclosure, it becomes possible to reduce the heat conduction between the adjacent electricity storage modules via the joining member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view showing the configuration of an electricity storage apparatus according to one embodiment;

FIG. 2 is a partially enlarged perspective view showing the configuration of the electricity storage apparatus according to one embodiment;

FIG. 3 is a plan view showing the configuration of the electricity storage apparatus according to one embodiment;

FIG. 4 is a partially enlarged view of the vicinity of a fixing portion in FIG. 2;

FIG. 5 is a sectional view taken along line V-V in FIG. 4;

FIG. 6 is a sectional view taken along line VI-VI in FIG. 4;

FIG. 7 is a sectional view taken along line VII-VII in FIG. 3; and

FIG. 8 is a side view of the vicinity of a relay terminal block.

### DETAILED DESCRIPTION OF EMBODIMENTS

An embodiment of the present disclosure is described with reference to the drawings. In the drawings referred to below, the same members or members equivalent thereto are denoted by the same numerals.

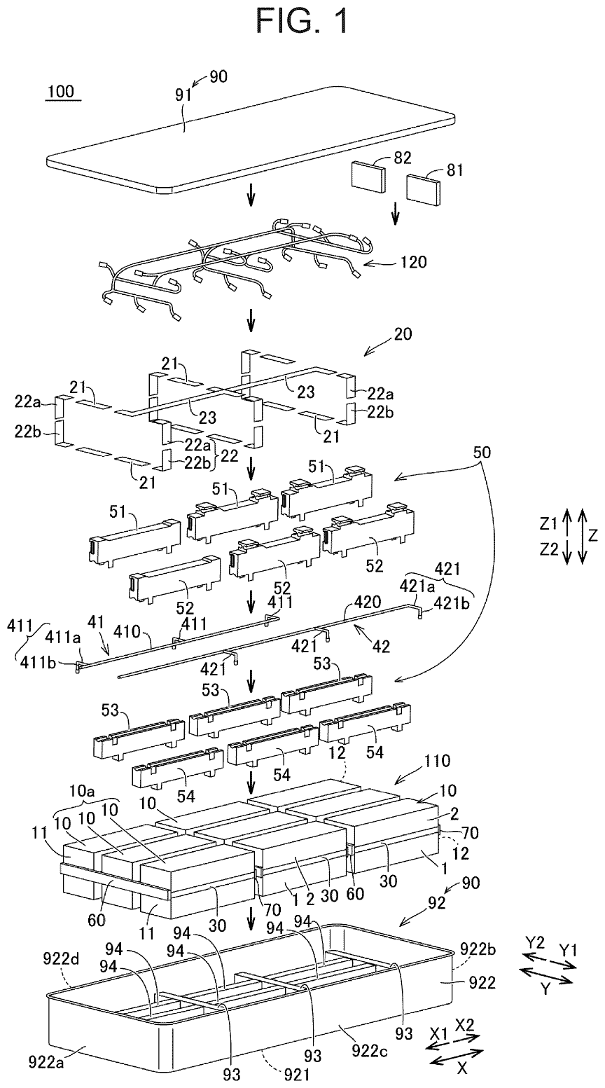

With reference to FIG. 1 to FIG. 8, an electricity storage apparatus 100 in one embodiment of the present disclosure is described. FIG. 1 is an exploded perspective view of the electricity storage apparatus 100 according to the present embodiment. The electricity storage apparatus 100 is mounted on a hybrid electric vehicle, a plug-in hybrid electric vehicle, a battery electric vehicle, and the like. The application of the electricity storage apparatus 100 is not limited to the vehicle application.

The X-direction, the Y-direction, and the Z-direction in the present specification are directions orthogonal to each other. For example, the X-direction and the Y-direction are the front-rear direction and the vehicle width direction of the vehicle, respectively, when the electricity storage apparatus 100 is mounted on the vehicle. The X1-direction and the X2-direction are a direction toward a place ahead of the vehicle and a direction toward a place behind the vehicle, respectively, in the vehicle front-rear direction. The Y1-direction and the Y2-direction are a direction toward a place on the left side of the vehicle and a direction toward a place on the right side of the vehicle, respectively, in the vehicle width direction. The Z-direction is an up-down (vertical) direction. The Z1-direction and the Z2-direction are the upper side and the lower side, respectively.

The electricity storage apparatus 100 according to the present embodiment is a battery pack, for example. The electricity storage apparatus 100 includes an electricity storage unit 110, bus bars 20, a plurality of coolers 30, cooling pipes 41, 42, resin members 50, joining brackets 60, 70, satellite battery monitors (SBMs) 81, 82, a case 90, and a wire harness 120. Each of the joining bracket 60 and the joining bracket 70 is one example of a “joining member” of the present disclosure.

The case 90 accommodates the electricity storage unit 110, the bus bars 20, the coolers 30, the cooling pipes 41, 42, the resin members 50, the joining brackets 60, 70, the SBMs 81, 82, and the wire harness 120. More specifically, the case 90 includes an upper case 91 and a lower case 92. The electricity storage unit 110, the bus bars 20, the coolers 30, the cooling pipes 41, 42, the resin members 50, the joining brackets 60, 70, the SBMs 81, 82, and the wire harness 120 are accommodated in a space formed by the upper case 91 and the lower case 92. Reinforcing members 93, 94 are provided in the lower case 92. Each of the joining brackets 60, 70 may be formed by aluminum, for example.

The lower case 92 includes a bottom wall 921 and peripheral walls 922. The peripheral walls 922 rise upward from peripheral edge portions of the bottom wall 921. The peripheral walls 922 are formed in a substantially quadrilateral tube-like form. The peripheral walls 922 includes side walls 922a, 922b, 922c, 922d. The side wall 922a and the side wall 922b are disposed to be spaced apart from each other in the X-direction. The side wall 922a is disposed on the X1-side relative to the side wall 922b. The side wall 922c and the side wall 922d are disposed to be spaced apart from each other in the Y-direction. The side wall 922c is disposed on the Y1-side relative to the side wall 922d.

The reinforcing members 93, 94 are provided in the lower case 92. Each of the reinforcing members 93, 94 is formed so as to protrude upward from the bottom wall 921 of the lower case 92. Each of the reinforcing members 93, 94 is fixed (for example, fastened or welded) to the bottom wall 921. Each of the reinforcing members 93, 94 is a plate-like member made of metal, for example.

The reinforcing members 93 and the reinforcing members 94 are each provided in plurality. The plurality (four in the present embodiment) of reinforcing members 93 is arranged to be spaced apart from each other in the X-direction. Each of the reinforcing members 93 extends in the Y-direction.

A plurality (two in the present embodiment) of the reinforcing members 94 is arranged to be spaced apart from each other in the Y-direction between the reinforcing members 93 arranged in the X-direction. In other words, in the present embodiment, six reinforcing members 94 are included. Each of the reinforcing members 94 extends in the X-direction.

An accommodating space in the case 90 is partitioned into a plurality of (nine in the present embodiment) spaces by the reinforcing members 93, 94. One electricity storage module 10 is disposed in each of the nine spaces. A smoke exhaustion path through which gas and smoke flow is formed on the inside of each of the reinforcing members 93 and the reinforcing members 94.

The electricity storage modules 10 are disposed in a matrix of 3×3 in an XY-plane. Specifically, three module columns 10a each formed by three electricity storage modules 10 arranged in the Y-direction are arranged in the X-direction.

Each of the coolers 30 cools the electricity storage modules 10 of a different one of the module columns 10a. In other words, three coolers 30 are included. Each of the coolers 30 extends in the Y-direction so as to spread across the three electricity storage modules 10 arranged in the Y-direction.

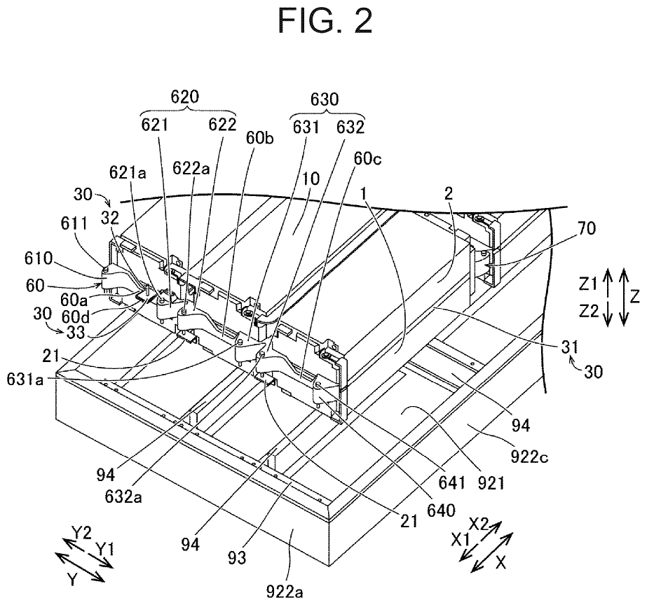

Each electricity storage module 10 includes a lower module 1 and an upper module 2. The lower module 1 is disposed below (on the Z2-side of) the upper module 2. The lower modules 1 and the upper modules 2 are stacked in the Z-direction so as to sandwich cooling plates 31 (described below, FIG. 2) of the coolers 30 therebetween. The cooler 30 (cooling plate 31) extends in the Y-direction so as to pass through a place between the lower modules 1 and the upper modules 2 in each of the module columns 10a. The lower module 1 and the upper module 2 are examples of a “first module” and a “second module” of the present disclosure, respectively.

The electricity storage modules 10 are connected to each other in series by the bus bars 20. The bus bars 20 include bus bars 21, bus bars 22, and bus bars 23. The bus bars 21 electrically connect the electricity storage modules 10 lined up in the Y-direction to each other. The bus bars 22 electrically connect the lower modules 1 and the upper modules 2 lined up in the up-down direction to each other. The bus bars 23 electrically connect the module columns 10a lined up in the X-direction to each other.

Each bus bar 22 includes a bus bar 22a and a bus bar 22b. The bus bar 22a and the bus bar 22b are disposed to be adjacent to each other in the Z-direction. The bus bar 22a is disposed on the Z1-side relative to the bus bar 22b. The bus bar 22a is electrically connected to the upper module 2. The bus bar 22b is electrically connected to the lower module 1. The bus bar 22a and the bus bar 22b are examples of a “second bus bar” and a “first bus bar” of the present disclosure, respectively.

The cooling pipe 41 is a pipe for supplying a refrigerant to each cooler 30. The cooling pipe 41 is connected to each cooler 30. The cooling pipe 41 includes a cooling pipe 410 extending in the X-direction and three cooling pipes 411 that branch out from the cooling pipe 410 and protrude in the Y-direction (Y2-side). The cooling pipe 410 extends in the X-direction in a Y-direction position between the electricity storage module 10 disposed on the side closest to the Y2-side and the electricity storage module 10 in the center out of the three electricity storage modules 10 lined up in the Y-direction. The cooling pipes 411 extend along side surfaces 11 of the three electricity storage modules 10 lined up in the X-direction on the X1-side thereof. The cooling pipe 41 (410, 411) has a cylindrical shape.

Each cooling pipe 411 has a part 411a and a part 411b. The part 411a protrudes to the Y2-side from the cooling pipe 410. The part 411a extends in the Y-direction. The part 411b extends to the Z2-side from an end portion of the part 411a on the Y2-side thereof. The part 411b is connected to a cooling port 32 (FIG. 2) described below.

The cooling pipe 42 is a pipe for exhausting the refrigerant from each cooler 30. The cooling pipe 42 is connected to each cooler 30. The cooling pipe 42 includes a cooling pipe 420 extending in the X-direction and three cooling pipes 421 that branch out from the cooling pipe 420 and protrude in the Y-direction (Y1-side). The cooling pipe 420 extends in the X-direction in a Y-direction position between the electricity storage module 10 disposed on the side closest to the Y1-side and the electricity storage module 10 in the center out of the three electricity storage modules 10 lined up in the Y-direction. The cooling pipes 421 extend along side surfaces 12 of the three electricity storage modules 10 lined up in the X-direction on the X2-side thereof. The cooling pipe 42 (420, 421) has a cylindrical shape.

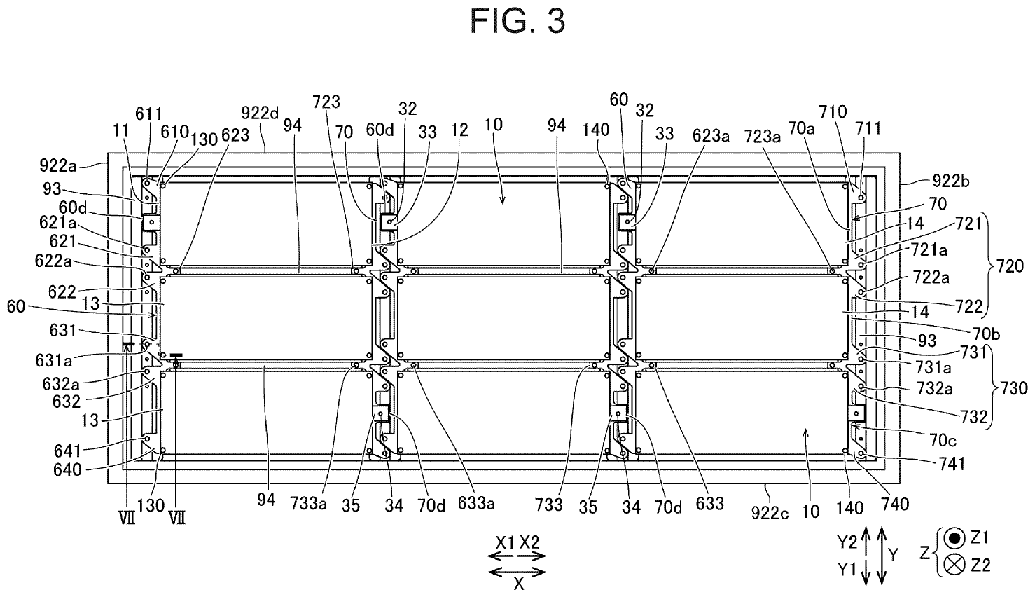

Each cooling pipe 421 has a part 421a and a part 421b. The part 421a protrudes to the Y1-side from the cooling pipe 420. The part 421a extends in the Y-direction. The part 421b extends to the Z2-side from an end portion of the part 421a on the Y1-side thereof. The part 421b is connected to a cooling port 34 (FIG. 3) described below.

The resin members 50 include three upper resin members 51 arranged to be spaced apart from each other in the X-direction and three upper resin members 52 spaced apart from each other in the X-direction. Each of the three upper resin members 51 is disposed on the Z1-side relative to the cooling pipe 410. Each of the three upper resin members 52 is disposed on the Z1-side relative to the cooling pipe 420.

The resin members 50 include three lower resin members 53 arranged to be spaced apart from each other in the X-direction and three lower resin members 54 spaced apart from each other in the X-direction. Each of the three lower resin members 53 is disposed on the Z2-side relative to the cooling pipe 410. Each of the three lower resin members 54 is disposed on the Z2-side relative to the cooling pipe 420.

The cooling pipe 410 is fixed by being interposed between the upper resin member 51 and the lower resin member 53 facing each other in the Z-direction. The cooling pipe 420 is fixed by being interposed between the upper resin member 52 and the lower resin member 54 facing each other in the Z-direction.

The SBMs 81, 82 are units for monitoring the state of the electricity storage modules 10 (for example, the temperature, the voltage, and/or the current of the electricity storage modules 10). The SBM 81 monitors the state of the upper module 2 of each electricity storage module 10. The SBM 82 monitors the state of the lower module 1 of each electricity storage module 10.

The wire harness 120 connects each of the SBM 81 and the SBM 82 and the electricity storage modules 10 to each other.

The joining brackets 60, 70 join the three electricity storage modules 10 of each module column 10a to each other. The joining brackets 60, 70 extend in the Y-direction so as to straddle across the three electricity storage modules 10. The joining bracket 60 is provided on the side surfaces 11 of the electricity storage modules 10. The joining bracket 70 is provided on the side surfaces 12 of the electricity storage modules 10.

FIG. 2 is a partially enlarged view of the vicinity of the joining bracket 60. In FIG. 2, the illustration of the cooling pipes 41, 42 is omitted for simplification.

Each of the joining brackets 60 includes a joining piece 610, a joining piece 620, a joining piece 630, and a joining piece 640.

Each joining bracket 60 includes a connecting portion 60a, a connecting portion 60b, and a connecting portion 60c. The connecting portion 60a connects the joining piece 610 and the joining piece 620 to each other. The connecting portion 60b connects the joining piece 620 and the joining piece 630 to each other. The connecting portion 60c connects the joining piece 630 and the joining piece 640 to each other. Each of the connecting portion 60a, the connecting portion 60b, and the connecting portion 60c extends in the Y-direction.

The joining piece 620 has a piece portion 621 and a piece portion 622 adjacent to each other in the Y-direction. The joining piece 630 has a piece portion 631 and a piece portion 632 adjacent to each other in the Y-direction.

The joining piece 610 is disposed in the vicinity of a Y2-side end portion of the electricity storage module 10 closest to the Y2-side out of the three electricity storage modules 10 arranged in the Y-direction (hereinafter referred to as the electricity storage module 10 on the Y2-side). The piece portion 621 is disposed in the vicinity of a Y1-side end portion of the electricity storage module 10 on the Y2-side.

The piece portion 622 is disposed in the vicinity of a Y2-side end portion of the electricity storage module 10 in the center out of the three electricity storage modules 10 arranged in the Y-direction (hereinafter referred to as the electricity storage module 10 in the center). The piece portion 631 is disposed in the vicinity of a Y1-side end portion of the electricity storage module 10 in the center.

The piece portion 632 is disposed in the vicinity of a Y2-side end portion of the electricity storage module 10 closest to the Y1-side out of the three electricity storage modules 10 arranged in the Y-direction (hereinafter referred to as the electricity storage module 10 on the Y1-side). The joining piece 640 is disposed in the vicinity of a Y1-side end portion of the electricity storage module 10 on the Y1-side.

The electricity storage apparatus 100 includes a bolt 611, a bolt 621a, a bolt 622a, a bolt 631a, a bolt 632a, and a bolt 641. The bolt 611, the bolt 621a, the bolt 622a, the bolt 631a, the bolt 632a, and the bolt 641 respectively fasten the joining piece 610, the piece portion 621, the piece portion 622, the piece portion 631, the piece portion 632, and the joining piece 640, and the reinforcing member 93 to each other.

Each cooler 30 is formed by metal (for example, aluminum). The cooler 30 includes the cooling plate 31, the cooling port 32, and a port supporting portion 33. The cooling plate 31 is interposed between the upper modules 2 and the lower modules 1.

Each cooling plate 31 has a rectangular plate-like external form, for example. The refrigerant supplied from the cooling pipe 41 (FIG. 1) flows through the inside of the cooling plates 31. As a result, each of the upper modules 2 and the lower modules 1 sandwiching the cooling plates 31 therebetween is cooled. The cooling port 32 is a port through which the refrigerant flows into the cooling plate 31. The cooling pipe 411 (FIG. 1) is connected to the cooling port 32. The port supporting portion 33 supports the cooling port 32 from the Z2-side. The cooling port 32 extends to the Z1-side from the port supporting portion 33.

The port supporting portion 33 protrudes to the X1-side from a part of the cooling plate 31 corresponding to the electricity storage module 10 on the Y2-side.

The joining bracket 60 includes a supporting portion 60d. The supporting portion 60d supports the port supporting portion 33 from the Z2-side. The supporting portion 60d protrudes to the X1-side from the connecting portion 60a.

FIG. 3 is a plan view of the electricity storage apparatus 100 seen from the Z1-side. The joining piece 620 has a connecting piece portion 623. The connecting piece portion 623 connects the piece portion 621 and the piece portion 622 to each other. The connecting piece portion 623 is disposed between the electricity storage module 10 on the Y2-side and the electricity storage module 10 in the center. The joining piece 630 has a connecting piece portion 633. The connecting piece portion 633 connects the piece portion 631 and the piece portion 632 to each other. The connecting piece portion 633 is disposed between the electricity storage module 10 on the Y1-side and the electricity storage module 10 in the center.

The electricity storage apparatus 100 has a bolt 623a and a bolt 633a. The bolt 623a fastens the connecting piece portion 623 and an end portion of the reinforcing member 94 on the X1-side thereof to each other. The bolt 633a fastens the connecting piece portion 633 and an end portion of the reinforcing member 94 on the X1-side thereof to each other.

Each joining bracket 70 includes a joining piece 710, a joining piece 720, a joining piece 730, and a joining piece 740.

Each joining bracket 70 includes a connecting portion 70a, a connecting portion 70b, and a connecting portion 70c. The connecting portion 70a connects the joining piece 710 and the joining piece 720 to each other. The connecting portion 70b connects the joining piece 720 and the joining piece 730 to each other. The connecting portion 70c connects the joining piece 730 and the joining piece 740 to each other. Each of the connecting portion 70a, the connecting portion 70b, and the connecting portion 70c extends in the Y-direction.

The joining piece 720 has a piece portion 721 and a piece portion 722 adjacent to each other in the Y-direction. The joining piece 730 has a piece portion 731 and a piece portion 732 adjacent to each other in the Y-direction.

The joining piece 710 is disposed in the vicinity of a Y2-side end portion of the electricity storage module 10 on the Y2-side. The piece portion 721 is disposed in the vicinity of a Y1-side end portion of the electricity storage module 10 on the Y2-side.

The piece portion 722 is disposed in the vicinity of a Y2-side end portion of the electricity storage module 10 in the center. The piece portion 731 is disposed in the vicinity of a Y1-side end portion of the electricity storage module 10 in the center.

The piece portion 732 is disposed in the vicinity of a Y2-side end portion of the electricity storage module 10 on the Y1-side. The joining piece 740 is disposed in the vicinity of a Y1-side end portion of the electricity storage module 10 on the Y1-side.

The electricity storage apparatus 100 includes a bolt 711, a bolt 721a, a bolt 722a, a bolt 731a, a bolt 732a and a bolt 741. The bolt 711, the bolt 721a, the bolt 722a, the bolt 731a, the bolt 732a, and the bolt 741 respectively fasten the joining piece 710, the piece portion 721, the piece portion 722, the piece portion 731, the piece portion 732, and the joining piece 740, and the reinforcing member 93 to each other.

Each cooler 30 includes the cooling port 34 and a port supporting portion 35. The cooling port 34 is a port through which the refrigerant flows from the cooling plate 31 (FIG. 2). The cooling pipe 421 (FIG. 1) is connected to the cooling port 34. The port supporting portion 35 supports the cooling port 34 from the Z2-side. The cooling port 34 extends to the Z1-side from the port supporting portion 35.

The port supporting portion 35 protrudes to the X2-side from a part of the cooling plate 31 (FIG. 2) corresponding to the electricity storage module 10 on the Y1-side.

The joining bracket 70 includes a supporting portion 70d. The supporting portion 70d supports the port supporting portion 35 from the Z2-side. The supporting portion 70d protrudes to the X2-side from the connecting portion 70c.

The joining piece 720 has a connecting piece portion 723. The connecting piece portion 723 connects the piece portion 721 and the piece portion 722 to each other. The connecting piece portion 723 is disposed between the electricity storage module 10 on the Y2-side and the electricity storage module 10 in the center. The joining piece 730 has a connecting piece portion 733. The connecting piece portion 733 connects the piece portion 731 and the piece portion 732 to each other. The connecting piece portion 733 is disposed between the electricity storage module 10 on the Y1-side and the electricity storage module 10 in the center.

The electricity storage apparatus 100 includes a bolt 723a and a bolt 733a. The bolt 723a fastens the connecting piece portion 723 and an end portion of the reinforcing member 94 on the X2-side thereof to each other. The bolt 733a fastens the connecting piece portion 733 and an end portion of the reinforcing member 94 on the X2-side thereof to each other.

Each of the electricity storage modules 10 has a joining part 13 and a joining part 14. The joining part 13 extends in the Y-direction on an end portion of each electricity storage module 10 on the X1-side thereof. The joining part 14 extends in the Y-direction on an end portion of each electricity storage module 10 on the X2-side thereof.

The electricity storage apparatus 100 includes a plurality of bolts 130 and a plurality of bolts 140. The bolts 130 fasten the joining part 13 and the joining bracket 60 to each other. The bolts 140 fasten the joining part 14 and the joining bracket 70 to each other.

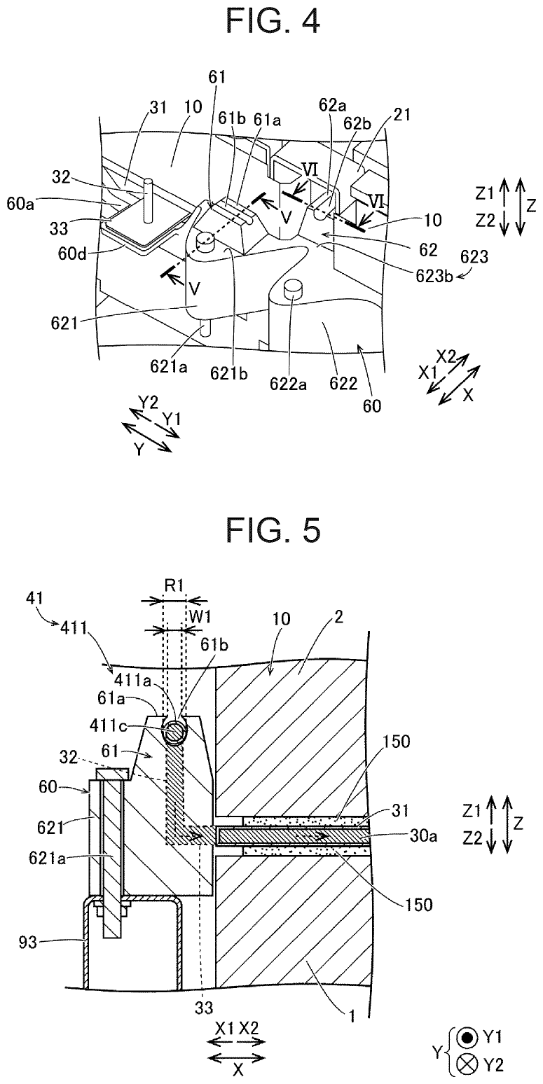

FIG. 4 is a partially enlarged view of the vicinity of the connecting piece portion 623 out of FIG. 2. The joining bracket 60 includes a fixing portion 61. The fixing portion 61 protrudes from an upper end surface 621b of the piece portion 621 to the Z1-side. The fixing portion 61 may be integrally provided with the piece portion 621 or may be provided as a body separate from the piece portion 621.

A groove portion 61b is formed in an upper end surface 61a of the fixing portion 61. The groove portion 61b extends in the Y-direction. Specifically, the groove portion 61b extends from an end portion of the upper end surface 61a on the Y1-side thereof to an end portion of the upper end surface 61a on the Y2-side thereof. A thermally conductive adhesive may be provided on a front surface of the groove portion 61b. Although illustration is omitted, a fixing portion having the same shape as the fixing portion 61 is also provided on an upper end surface of the piece portion 732 (FIG. 3).

The joining bracket 60 includes a fixing portion 62. The fixing portion 62 protrudes to the Z1-side from an upper end surface 623b of the connecting piece portion 623. The fixing portion 62 may be integrally provided with the connecting piece portion 623 or may be provided as a body separate from the connecting piece portion 623.

A groove portion 62b is formed in an upper end surface 62a of the fixing portion 62. The groove portion 62b extends in the X-direction. Specifically, the groove portion 62b extends from an end portion of the upper end surface 62a on the X1-side thereof to an end portion of the upper end surface 62a on the X2-side thereof. A thermally conductive adhesive may be provided on a front surface of the groove portion 62b. Although illustration is omitted, a fixing portion having the same shape as the fixing portion 62 is also provided on an upper end surface of the connecting piece portion 733.

Here, in a related-art electricity storage apparatus, when one electricity storage module causes thermal runaway, there is a risk that the heat is conducted to another electricity storage module via a joining bracket and thermal runaway is caused in the other electricity storage module.

Thus, in the present embodiment, the joining brackets 60 and the cooling pipe 41 are in thermal contact with each other. As a result, the joining bracket 60 is cooled by the refrigerant that flows through the cooling pipe 41, and hence it becomes possible to reduce the conduction of the heat (thermal chain) between the electricity storage modules 10 via the joining brackets 60.

Specifically, as shown in FIG. 5, the cooling pipe 411 of the cooling pipe 41 and the fixing portion 61 of the joining bracket 60 are in contact with each other. In detail, the part 411a of the cooling pipe 411 is accommodated in the groove portion 61b formed in the fixing portion 61. As a result, the cooling pipe 411 can be stably fixed. The part 411a is one example of a “groove accommodation part” of the present disclosure.

An opening width W1 of the groove portion 61b is smaller than a diameter R1 of the part 411a (cooling pipe 41). As a result, a case in which the part 411a comes off from the groove portion 61b is suppressed.

The cooling pipe 411 forms a flow path 411c through which the refrigerant flows. The cooling plate 31 forms a flow path 31a through which the refrigerant flows. The flow path 411c and the flow path 31a communicate with each other. As a result, as shown by broken-line arrows and a hatched part in FIG. 5, the refrigerant that flows through the flow path 411c of the cooling pipe 411 flows into the flow path 31a of the cooling plate 31 through the cooling port 32 and the port supporting portion 33. The flow path 31a and the flow path 411c are examples of a “cooler-side flow path” and a “pipe-side flow path” of the present disclosure, respectively.

As a result, a shared refrigerant can be caused to flow between the cooling plate 31 and the cooling pipe 41. As a result, the configuration of a circuit through which the refrigerant flows can be simplified as compared to a case in which different refrigerants are caused to flow through the cooling plate 31 and the cooling pipe 41.

The electricity storage apparatus 100 includes a thermally conductive adhesive 150. The thermally conductive adhesive 150 is provided between the cooling plate 31 and each of the upper module 2 and the lower module 1.

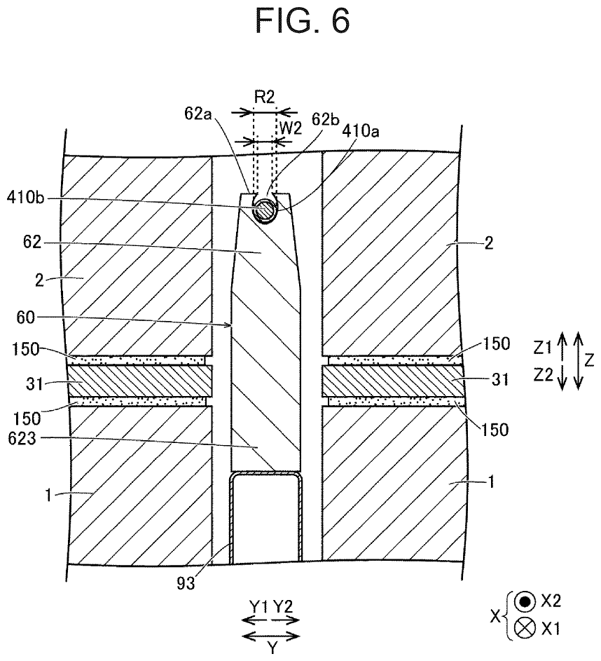

FIG. 6 is a sectional view taken along line VI-VI in FIG. 4. As shown in FIG. 6, the cooling pipe 410 of the cooling pipe 41 and the fixing portion 62 of the joining bracket 60 are in contact with each other. In detail, a part 410a of the cooling pipe 410 is accommodated in the groove portion 62b formed in the fixing portion 62. The part 410a is one example of the “groove accommodation part” of the present disclosure.

An opening width W2 of the groove portion 62b is smaller than a diameter R2 of the cooling pipe 410. As a result, the cooling pipe 410 is restrained from falling out of the groove portion 62b, and the misalignment of the cooling pipe 410 is reduced.

The cooling pipe 410 forms a flow path 410b through which the refrigerant flows. The flow path 410b communicates with the flow path 411c of the cooling pipe 411 (FIG. 5).

Although illustration is omitted, the cooling pipe 42 and the joining bracket 70 also have the same configuration as FIG. 5 and FIG. 6.

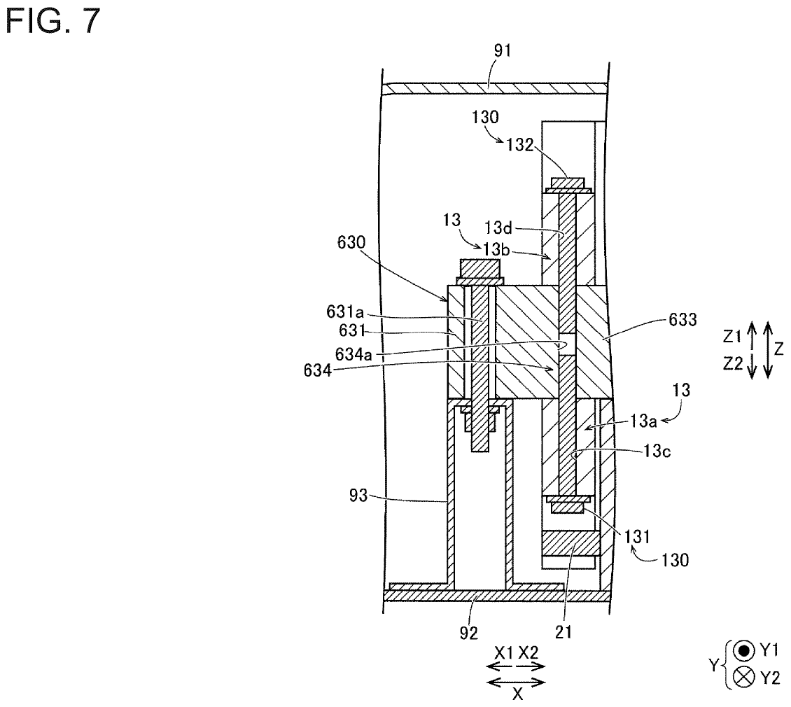

FIG. 7 is a sectional view taken along line VII-VII in FIG. 3. The joining piece 630 has a piece portion 634. The piece portion 634 is provided between the piece portion 631 and the connecting piece portion 633. A through-hole 634a extending in the Z-direction is formed in the piece portion 634. The through-hole 634a is threaded.

The joining part 13 of the electricity storage module 10 includes a lower joining part 13a and an upper joining part 13b. The lower joining part 13a and the upper joining part 13b are provided on the lower module 1 and the upper module 2, respectively. A through-hole 13c and a through-hole 13d extending in the Z-direction are formed in the lower joining part 13a and the upper joining part 13b, respectively.

The bolts 130 include a bolt 131 and a bolt 132. A shaft portion of the bolt 131 passes through the through-hole 13c of the lower joining part 13a and is inserted into the through-hole 634a of the piece portion 634 from the lower side. A shaft portion of the bolt 132 passes through the through-hole 13d of the upper joining part 13b and is inserted into the through-hole 634a of the piece portion 634 from the upper side. As a result, the joining bracket 60 (piece portion 634) is fastened to each of the upper module 2 and the lower module 1. As a result, each of the upper module 2 and the lower module 1 can be cooled by the joining bracket 60 cooled by the refrigerant.

Although illustration is omitted, each of the joining piece 610, the piece portion 621, the piece portion 622, the piece portion 632, and the joining piece 640 (FIG. 2) can also be fastened to each of the upper module 2 and the lower module 1 as with the piece portion 634. Although illustration is omitted, the joining bracket 70 and the joining part 14 are also fastened as with the joining bracket 60 and the joining part 13. In other words, each of the joining piece 710, the piece portion 721, the piece portion 722, the piece portion 731, the piece portion 732, and the joining piece 740 of the joining bracket 70 is fastened to each of the upper module 2 and the lower module 1.

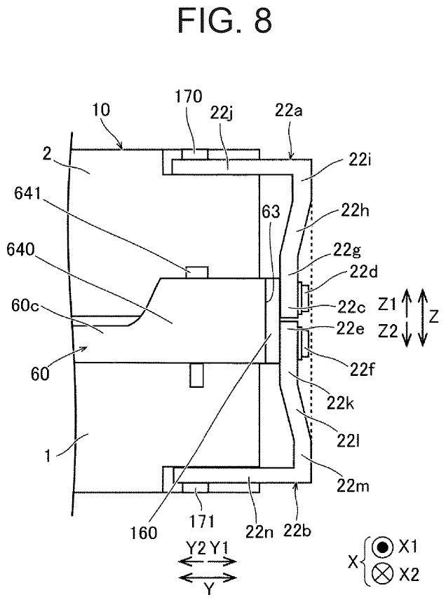

FIG. 8 is a partially enlarged view of the vicinity of an end portion of the joining bracket 60 on the Y1-side thereof. In FIG. 8, the illustration of the reinforcing member 93 is omitted for simplification.

The electricity storage apparatus 100 includes relay terminal blocks 160. The relay terminal block 160 is provided on an end surface 63 of each joining bracket 60 on the Y1-side thereof. The relay terminal blocks 160 may also be provided on an end surface of each joining bracket 60 on the Y2-side thereof and each of both end surfaces of each joining bracket 70 in the Y-direction.

An end portion 22c of the bus bar 22a on the Z2-side thereof is fastened to the relay terminal block 160 by a bolt 22d. An end portion 22e of the bus bar 22b on the Z1-side thereof is fastened to the relay terminal block 160 by a bolt 22f. As a result, the bus bar 22a and the bus bar 22b are electrically connected to each other via the relay terminal block 160.

As a result, each of the bus bar 22a and the bus bar 22b comes into contact with the joining bracket 60, and hence each of the bus bar 22a and the bus bar 22b can be cooled by the refrigerant that flows through the cooling pipe 41 (FIG. 5) via the joining bracket 60. The relay terminal block 160 can also be cooled by the refrigerant that flows through the cooling pipe 41 via the joining bracket 60.

Each of the bus bar 22a and the bus bar 22b can be stably fixed as a result of each of the bus bar 22a and the bus bar 22b being fixed to the relay terminal block 160. As a result, the concentration of stress to predetermined sections (for example, parts fastened with the electricity storage module 10) of the bus bar 22a and the bus bar 22b can be alleviated. Each of the bus bar 22a and the bus bar 22b is fixed by the relay terminal block 160, and hence a variation in position of each of the bus bar 22a and the bus bar 22b in the Z-direction can be reduced. As a result, the concentration of stress to predetermined sections (for example, parts fastened with the electricity storage module 10) of the bus bar 22a and the bus bar 22b can be reduced more.

The bus bars 22a include a first part 22g, a second part 22h, a third part 22i, and a fourth part 22j in addition to the end portion 22c. The first part 22g is connected to an upper end portion of the end portion 22c and extends to the Z1-side from the end portion 22c.

The second part 22h extends toward the Z1-side from an upper end portion of the first part 22g. Specifically, the second part 22h is inclined in a direction (Y1-side) separating from the electricity storage module 10 as the second part 22h extends toward the Z1-side.

The third part 22i extends to the Z1-side from an upper end portion of the second part 22h. The fourth part 22j extends to the side of the Y2-side (electricity storage module 10) from an upper end portion of the third part 22i. In other words, the third part 22i and the fourth part 22j are orthogonal to each other. As above, the bus bar 22a has a crank shape in which a plurality of bending portions is formed. The fourth part 22j is fastened by the upper module 2 and a bolt 170.

The position (the broken line in FIG. 8) of an end portion of the third part 22i on the Y1-side thereof is positioned on the Y1-side (the direction separating from the electricity storage module 10) relative to the bolt 22d (bolt 22f). In other words, the third part 22i protrudes to the Y1-side more than the bolt 22d (bolt 22f). As a result, even when impact is applied to the electricity storage module 10 from the Y1-side, and hence the input of the impact to the bolt 22d and the bolt 22f (relay terminal block 160) can be alleviated by the interference of the third part 22i.

The bus bar 22b has a first part 22k, a second part 22l, a third part 22m, and a fourth part 22n in addition to the end portion 22e. The first part 22k is connected to a lower end portion of the end portion 22e and extends to the Z2-side from the end portion 22c.

The second part 22l extends toward the Z2-side from a lower end portion of the first part 22k. Specifically, the second part 22l is inclined in the direction (Y1-side) separating from the electricity storage module 10 as the second part 22l extends toward the Z2-side.

The third part 22m extends to the Z2-side from a lower end portion of the second part 22l. The fourth part 22n extends to the side of the Y2-side (electricity storage module 10) from a lower end portion of the third part 22m. In other words, the third part 22m and the fourth part 22n are orthogonal to each other. As above, the bus bar 22b has a crank shape in which a plurality of bending portions is formed. The fourth part 22n is fastened by the lower module 1 and a bolt 171.

The position (the broken line in FIG. 8) of an end portion of the third part 22m on the Y1-side thereof is positioned on the Y1-side (the direction separating from the electricity storage module 10) relative to the bolt 22d (bolt 22f). In other words, the third part 22m protrudes to the Y1-side more than the bolt 22d (bolt 22f).

The configuration shown in FIG. 8 is provided on each of both end portions of each of the joining brackets 60, 70 in the Y-direction.

As above, in the present embodiment, the joining bracket 60 (70) and the cooling pipe 41 (42) are in thermal contact with each other. Therefore, the joining bracket 60 (70) can be cooled by the refrigerant. As a result, the heat conduction between the electricity storage modules 10 via the joining bracket 60 (70) can be reduced.

### MODIFIED EXAMPLES

In the embodiment described above, an example in which the cooling pipe and the joining bracket are in direct contact with each other has been shown, but the present disclosure is not limited thereto. For example, a thermally conductive adhesive may be provided between the cooling pipe and the joining bracket. In other words, the joining bracket may be indirectly cooled by the cooling pipe via a thermally conductive adhesive. In this case, the cooling pipe may be formed in a quadrilateral tube-like form in order to increase the area in contact with the joining bracket.

In the embodiment described above, an example in which the bus bar 22a and the bus bar 22b are electrically connected to each other via the relay terminal block 160 has been shown, but the present disclosure is not limited thereto. The upper module 2 and the lower module 1 are electrically connected to each other by a single bus bar.

In the embodiment described above, an example in which the cooling pipe is housed in the groove portion of the joining bracket has been shown, but the present disclosure is not limited thereto. For example, the cooling pipe may be caused to pass through a through-hole formed in the joining bracket.

In the embodiment described above, an example in which the joining bracket and the electricity storage module are fastened to each other by the bolts has been shown, but the present disclosure is not limited thereto. For example, the joining bracket may be welded (or caused to adhere) to the electricity storage module.

The configurations of the embodiment and each of the modified examples may be combined with each other.

It is to be understood that the embodiments disclosed above are merely examples in all aspects and in no way intended to limit the disclosure. The scope of the present disclosure is defined by the scope of the claims and not by the description of the embodiment. All modifications made within the scope and spirit equivalent to those of the claims are included in the disclosure.

What is claimed is:

1. An electricity storage apparatus, comprising:
a plurality of electricity storage modules;
a joining member configured to join adjacent electricity storage modules out of the electricity storage modules to each other; and
a cooling pipe through which a refrigerant flows,
wherein the joining member and the cooling pipe are in thermal contact with each other.

2. The electricity storage apparatus according to claim 1, further comprising a cooler configured to cool the electricity storage modules, wherein:
each of the electricity storage modules includes a first module and a second module stacked so as to sandwich the cooler between the first module and the second module;
the cooling pipe provides a pipe-side flow path through which the refrigerant flows; and
the cooler provides a cooler-side flow path that communicates with the pipe-side flow path.

3. The electricity storage apparatus according to claim 2, wherein the joining member is connected to each of the first module and the second module.

4. The electricity storage apparatus according to claim 2, further comprising:
a first bus bar electrically connected to the first module;
a second bus bar electrically connected to the second module; and
a relay terminal block configured to electrically connect the first bus bar and the second bus bar to each other by being connected to each of the first bus bar and the second bus bar, the relay terminal block being provided in the joining member.

5. The electricity storage apparatus according to claim 1, wherein:
a groove portion is provided in the joining member; and
the cooling pipe has a groove accommodation part accommodated in the groove portion.
